(19) United States
(12) Patent Application Publication
(10) Pub. No.: US 2025/0269621 A1
(43) Pub. Date: Aug. 28, 2025

(54) EMBOSSER COMPRISING A DISPENSER FOR STIFFENING A PLY OF PAPER, CONVERTING LINE AND PROCESS

(71) Applicant: GAMBINI S.P.A., Milano (IT)

(72) Inventors: Paolo LAZZARESCHI, LUCCA (IT); Giovanni BUFFA, Ponte Buggianese (PT) (IT); Fabio PICCHI, Lammari LUCCA (IT)

(73) Assignee: GAMBINI S.P.A., Milano (IT)

(21) Appl. No.: 19/060,975

(22) Filed: Feb. 24, 2025

(30) Foreign Application Priority Data
Feb. 26, 2024 (IT) 102024000004033

(51) Int. Cl. B31F 1/07; B32B 3/30; B32B 29/00; D21H 27/00; D21H 27/32

(52) U.S. Cl. CPC B31F 1/07; B32B 3/30; B32B 29/005; D21H 27/002; D21H 27/32; B31F 2201/0715; B31F 2201/0761; B31F 2201/0787; B32B 2250/02; B32B 2250/26

(57) ABSTRACT

Provided is an embosser that contains a first embossing unit configured to emboss a first ply (P) of tissue paper wound between a first upper roller and a first lower roller; and a second embossing unit configured to emboss a second ply (P′) of tissue paper wound between a second upper roller and a second lower roller. The first lower roller and the second upper roller are at least close defining a coupling zone (C) of the plies (P) and (P′). The embosser further contains at least one dispenser placed upstream of the coupling zone (C) and configured to dispense a predetermined amount of a stiffening substance on a predetermined area A of the embossed ply (P) or (P′). Also provided are a converting line for processing tissue paper and a process to stiffen a ply of tissue paper to be coil-winded around a core to be extracted.

The present invention relates to an embosser comprising a dispenser for stiffening a ply of paper, and to a converting line comprising such embosser. The present invention further relates to a process to stiffen a ply to be coil-winded around a core to be extracted. The present invention finds useful employment in the field of paper of the so-called “tissue” typology, i.e., paper for products such as toilet paper, kitchen paper, and the like.

Indeed, it is known to produce rolls of laminated tissue paper with multiple plies, generally two or three plies, starting from reels of paper material, so-called “logs”, which have a greater length but the same diameter as the final paper roll. Such logs are obtained by winding, on a cardboard core generally made of a tubular element, by means of rewinding machines, a web of paper previously subjected to various processing.

In order to form a roll of paper for final applications, the logs are cut into various units to produce single rolls of paper of smaller lengths.

So-called “coreless” reels of paper are known, in which the paper is layer-wound so as to form a roll that, however, is free of core. In particular, such reels have been provided in recent years to address environmental problems and with a view toward recycling.

In particular, for such products, it is known to make the log comprising the core, as the latter carries out a structural support function during the winding procedure, and subsequently remove the core before cutting the log into the single rolls.

The step of extracting the core is a critical phase, as part of the log is often damaged, in particular the innermost coils of paper connected to the core are subjected to deformations or tears.

In order to overcome such problem, a system has been developed that involves distributing a substance which stiffens the paper on it, between one coil and another of a log being wound, so as to reinforce the log innermost coils closest to the core. In this way, a sort of central nucleus is generated in the proximity to the core due to stiffer coils which, when the core is extracted, remain more compact and are less subjected to deformations/tears. The stiffening substance is dispensed on the paper by means of a series of nozzles placed in the rewinding machine, after the perforating rollers and before the winding rollers.

Disadvantageously, such system has the drawback of dirtying the rewinding machine, as the dispensed substance, which is substantially glue, is also scattered on the winding rollers of the rewinding machine. For this reason, it is periodically necessary to stop the line to clean the machine.

The task underlying the present invention consists in providing a system that allows to prevent the log innermost coils from damaging when the core is extracted.

In particular, an object of the present invention is to provide a system that, once the core is extracted, allows the central coils to be kept as undeformed as possible, even in the step of cutting by the cutting-off machine, after extracting the core.

Another object of the present invention is to keep the machines clean, preventing the line from being frequently stopped.

The above-mentioned task, as well as the stated objects and others that will be clearer hereinafter, are achieved by an embosser as cited in claim 1, by a converting line comprising such embosser as set forth in claim 10, and by a process to stiffen a ply of tissue paper to be coil-winded around a core to be extracted, as set forth in claim 11.

Other features are provided in the dependent claims.

Further features and advantages will appear more clearly from the description of preferred, but not exclusive, embodiments of an embosser, a converting line, and a process, illustrated by way of example and not limitation, with the aid of the attached drawings, in which:

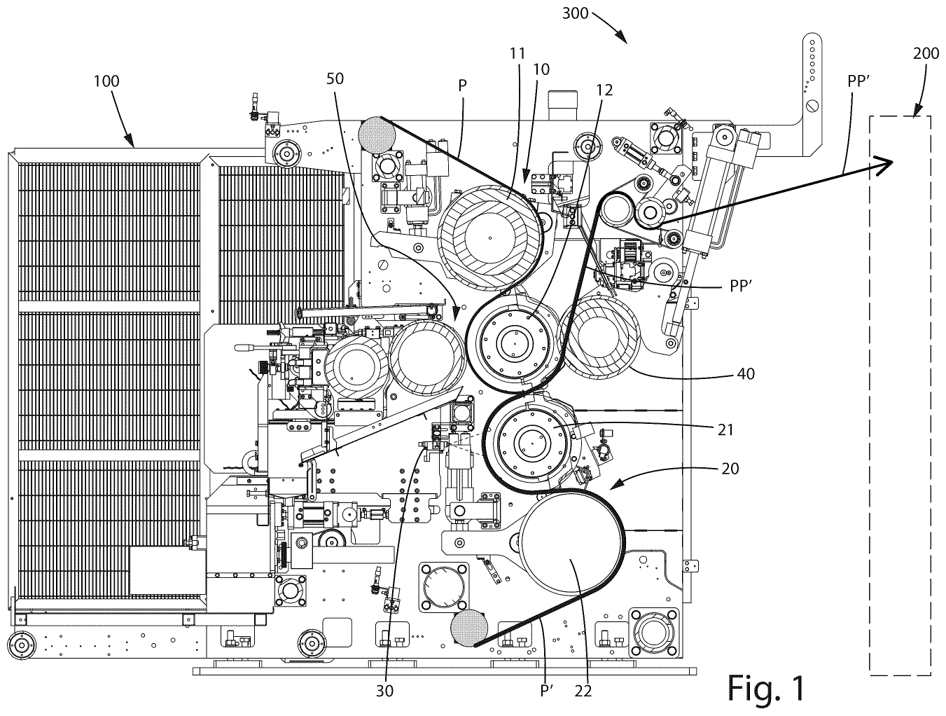

FIG. 1 schematically shows a converting line according to the present invention, with an embosser in a preferred embodiment, a sectional side view of which is shown;

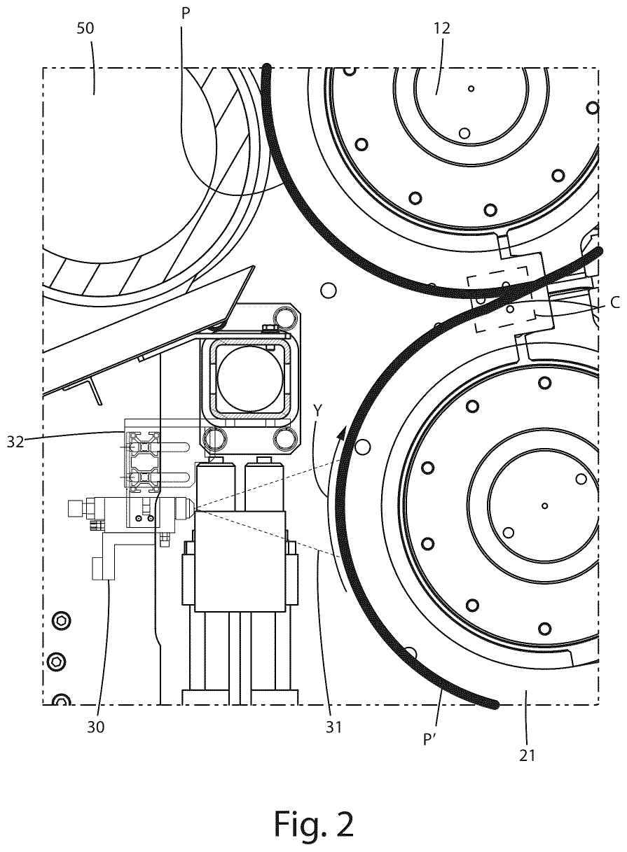

FIG. 2 shows an enlarged portion of the embosser of FIG. 1;

FIG. 3 shows a front view of a set of dispensers of the embosser of FIG. 1;

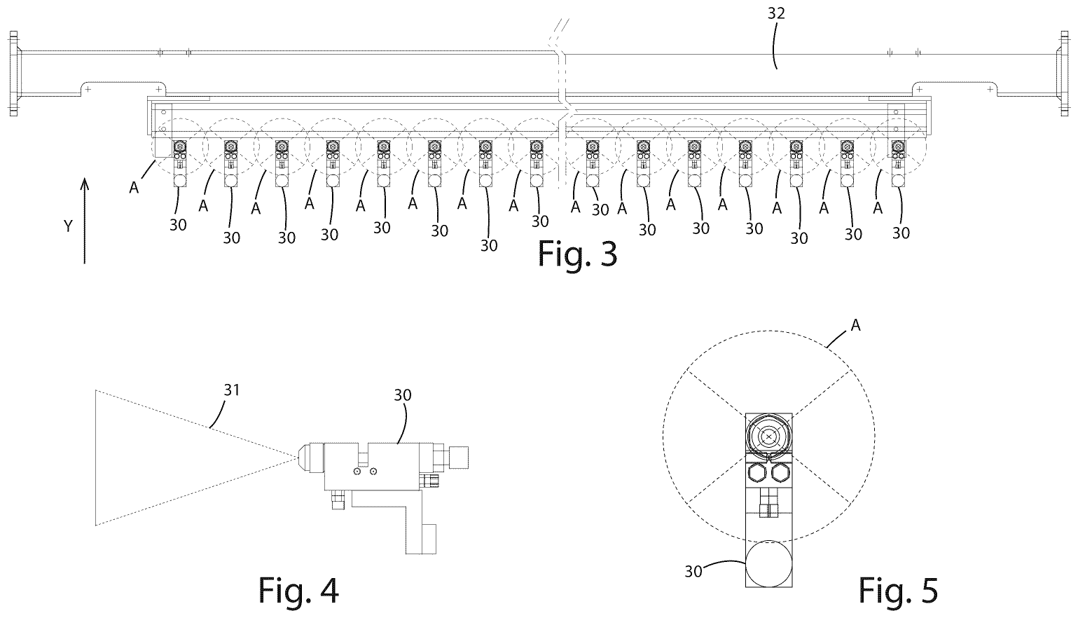

FIG. 4 shows a single dispenser of the embosser of FIG. 1;

FIG. 5 shows the dispenser of FIG. 4, in a front view.

With reference to the attached figures, an embosser identified by reference number 100 is described below.

The embosser 100 comprises a first embossing unit 10. The first unit 10 comprises at least a first upper roller 11 and a first lower roller 12, coupled to each other and configured to contact each other. The first unit 10 is configured to emboss a first ply P of tissue paper, wound between the first upper roller 11 and the first lower roller 12.

The embosser 100 comprises a second embossing unit 20. The second unit 20 comprises at least a second upper roller 21 and a second lower roller 22, coupled to each other and configured to contact each other. The second unit 20 is configured to emboss a second ply P′ of tissue paper, wound between the second upper roller 21 and the second lower roller 22.

Preferably, the first upper roller 11 and the second lower roller 22 are rubber-coated rollers, while the first lower roller 12 and the second upper roller 21 are embossing rollers, i.e., steel rollers having tips arranged according to a specific pattern to impart such pattern on the ply P, P′.

In particular, the first lower roller 12 and the second upper roller 21 face each other and are at least close, defining a coupling zone C of such plies P, P′. Indeed, in accordance with the illustrated embodiment, the first lower roller 12 and the second upper roller 21 are close but spaced, and therefore the plies of paper P, P′ come closer and face each other as they pass through the space between the first lower roller 12 and the second upper roller 21, without being joined in a multi-layer ply PP′. In order to be joined in a multi-layer ply PP′, the aid of a further roller, described below, is required, which is in contact with one of the first lower roller 12 and the second upper roller 21. In accordance with alternative embodiments, the first lower roller 12 and the second upper roller 21 are in contact with each other and can therefore directly join the plies P, P′. In this case, the coupling zone C corresponds to the joining of the plies P, P′ in a multi-layer ply PP′.

In accordance with the present invention, the embosser 100 comprises at least one dispenser 30 of a stiffening substance. Such dispenser 30 is positioned at the first lower roller 12 and/or the second upper roller 21. The dispenser 30 can be also positioned in an intermediate position between the first lower roller 12 and the second upper roller 21.

The dispenser 30 is configured to face an embossed ply P, P′.

With an “embossed” ply it is meant the same ply P, P′, i.e. wound between the first upper roller 11 and the first lower roller 12 or between the second upper roller 21 and the second lower roller 22, after it has been embossed.

For example, the dispenser 30 is placed at the second upper roller 21, as illustrated in FIGS. 1 and 2. The dispenser 30 can also be placed at the first lower roller 12 or midway between such two rollers 21, 12.

The dispenser 30 is configured to dispense a predetermined amount of the stiffening substance on a predetermined area A of the embossed ply P, P′. In particular, such predetermined area A is placed upstream of the coupling zone C. In other words, the dispenser 30 is adapted to dispense the stiffening substance on the ply P, P′ before it is coupled to the other ply P′, P and subsequently joined thereto.

In this way, the stiffening substance is interposed between the two plies P, P′ when these are joined in a single multi-layer ply PP′.

In the context of the present description, the expressions “upstream” and “downstream” are intended with respect to the advancement direction of the plies P, P′ or the multi-layer ply PP′.

The stiffening substance is preferably a glue. The glue is, for example, a glue known to those skilled in the art as an edge-gluing glue.

The glue can also be of the type of tube glue, pick-up glue, or laminating glue, appropriately diluted to have good release.

Indeed, the glue must have good release, i.e., once the multi-layer ply PP′ is coil-winded, it must allow the coils to be opened to allow a final user to also use the plies forming the inner coils without wasting product.

According to a preferred embodiment, the embosser 100 comprises a plurality of dispensers 30 placed side by side to each other.

Each dispenser 30 is configured to dispense a predetermined amount of such stiffening substance. Preferably, the predetermined amount is comprised from 1 g/m² to 10 g/m².

The dispensing can be continuous or discontinuous. Preferably, the dispensers 30 are configured to dispense by spraying.

Preferably, each dispenser 30 is adapted to dispense the stiffening substance according to a spray cone 31 defining the predetermined area A. In particular, FIGS. 3 and 5 schematize, by a dashed line, the spray impression on the ply P, P′, corresponding to the predetermined area A.

Preferably, the dispensers 30 are positioned so that the predetermined areas A are adjacent to each other along a direction transverse to the advancement direction Y of the ply P, P′.

Preferably, the dispensers 30 are positioned so that the predetermined areas A are contiguous. In other words, preferably, the predetermined areas A are close enough to share at least one common section. Advantageously, each roll into which the log will be cut will have the stiffening substance distributed homogeneously.

More preferably, the predetermined areas A are at least partially overlapping.

Preferably, each dispenser 30 is configured to dispense the stiffening substance only at specific steps of embossing/laminating, for a predetermined time. This predetermined time is shorter than the total time required for embossing/laminating of the plies P, P′. In other words, dispenser 30 dispenses, in use, the stiffening substance for limited times spaced at predefined intervals with each other, while embosser 100 is in operation, so as to dispense the stiffening substance onto areas of the ply that, during the winding process with the rewinding machine, will be placed in the initial parts of the various rolls, in order to stiffen only the first few coils of each roll being formed.

Still preferably, each dispenser 30 is configured to dispense the stiffening substance in subsequent times so as to cover predetermined areas A that are adjacent along the advancement direction Y of the ply P, P′, preferably over a section comprised from 0.5 m to 2 m. More preferably, such section is approximately one meter. In this way, a log having at least some stiffened inner coils can be subsequently formed. Based on such section, indeed, in the final log, as well as in each finished roll cut from the log, there will be a higher or lower number of wound coils that will be stiffened.

In other words, considering a zone of the ply P, P′ on which the substance has been distributed by a single dispenser 30, the section is intended as the length of such zone along the advancement direction of the ply.

Preferably, the dispensers 30 are mounted on a support 32. Therefore, preferably, the dedicated embosser 100 comprises such support 32, optionally movable.

Preferably, the dispensers 30 are configured to be inclined and/or rotated.

In particular, the support 32 can be inclinable and/or rotatable, or the dispensers 30 themselves can have these features.

Depending on the position and orientation of each dispenser 30, the stiffening substance can be dispensed only on the first ply P, only on the second ply P′, or on both.

Preferably, the dispensers 30 are movable through commands placed on an external panel of the embosser 100, allowing an operator to vary the position of such dispensers 30 without needing to access the inside of the embosser 100.

In accordance with a preferred embodiment, as shown in figures, the embosser 100 comprises a coupling roller 40 placed downstream of the coupling zone C and coupled to the first lower roller 12 or the second upper roller 21. For example, the coupling roller 40 is coupled to the first lower roller 12.

The coupling roller 40 is configured to join the first ply P and the second ply P′ from the first unit 10 and the second unit 20 to form a multi-layer ply PP′.

Still in accordance with a preferred embodiment, as shown in figures, the embosser 100 comprises a glue assembly 50 placed upstream of the coupling zone C. The glue assembly 50 is associated to the first lower roller 12 or the second upper roller 21. The glue assembly 50 is configured to spread a layer of glue on an embossed ply P, P′.

The glue assembly 50 is separate from dispenser 30. In fact, the glue assembly 50 performs a different function from dispenser 30. Specifically, the glue assembly 50 is configured to spread glue continuously on the embossed plies P, P′ in order to join them together to form the multi-layer ply PP′. Therefore, in the formed roll, glue will be present on the entire multilayer PP′, unlike the stiffening substance, which in the formed roll will be present only in the first few coils.

In particular, the glue assembly 50, when present, is preferably associated to the roller 12, 21 to which the dispenser 30 is not associated.

For example, if the dispenser 30 is placed at the second upper roller 21, the glue assembly 50 is preferably placed at the first lower roller 12.

Alternatively, the dispenser 30 can be placed downstream of the glue assembly 50 if associated to the same roller.

In the case where the embosser 100 comprises the above-mentioned coupling roller 40 and glue assembly 50, the embosser 100 is referred to as a laminating embosser.

Another object of the present invention is a converting line 300 for processing tissue paper.

The converting line 300 comprises an embosser 100 as described above.

The converting line 300 comprises an unwinder (not illustrated in the attached drawings), placed upstream the embosser 100 and comprising respective unwinding rollers configured to unwind the first ply P and the second ply P′ of tissue paper.

The converting line 300 comprises a rewinding machine 200 placed downstream of the embosser 100 and configured to wind the multi-layer ply PP′, forming logs in succession.

In particular, the dispenser 30 is configured to dispense the stiffening substance at predetermined times, synchronously with the rewinding machine 200, so that the predetermined areas A define the log innermost coils, adjacent to a core to be extracted.

Indeed, each dispenser 30 is configured to dispense the stiffening substance at specific times based on the diameter the log will have, so that the stiffened portions are then the log inner coils, while the log outermost coils are free of the stiffening substance.

In other words, the times at which the stiffening substance is dispensed are synchronized with the exchanging step of the rewinding machine 200, so that the outgoing log is clean and has no glue on the free edge, while the cut part of edge that is yet to be wound is immediately provided with glue.

Another object of the present invention is a process to stiffen a ply P, P′ of tissue paper to be coil-winded around a core to be extracted.

The process comprises a first step of embossing a first ply P of tissue paper. The process comprises a step of embossing a second ply P′ of tissue paper. Generally, such step is carried out substantially simultaneously with the step of embossing a first ply P.

The process further comprises a step of joining the first ply P to the second ply P′ forming a multi-layer ply PP′.

In accordance with the present invention, the process comprises a further step of dispensing a stiffening substance on a ply P, P′. In particular, such step is carried out after the steps of embossing a first ply P and a second ply P′ and before the step of joining the first ply P to the second ply P′.

The process further comprises, after the step of joining the first ply P to the second ply P′, steps of winding a log and cutting and exchanging the formed log.

The steps listed above are carried out continuously in succession.

In particular, it should be noted that the step of dispensing a stiffening substance is synchronized with the step of cutting and exchanging the formed log.

Preferably, the process comprises a step of spreading a layer of glue on an embossed ply P, P′. This step applies in the case where the embosser 100 is a laminating embosser.

The step of dispensing a stiffening substance is separated from the step of spreading a layer of glue.

Specifically, the step of spreading a layer of glue is carried out continuously during embossing, in order to allow forming the multi-layer ply PP′. The step of dispensing a stiffening substance is instead carried out at predetermined times at regular intervals. In other words, the step of dispensing a stiffening substance is carried out a plurality of times, continuously but for a limited time, during embossing. The total duration of the step of dispensing a stiffening substance, considering the various repetitions over time, is therefore overall shorter with respect to the step of embossing and to the step of spreading a layer of glue, since the stiffening substance should involve only the first few coils of each roll being subsequently formed. Hence there will be as many steps in which the stiffening substance is not dispensed that separate the steps of dispensing from each other.

Specifically, the step of dispensing is carried out for a shorter time than the step of spreading.

In particular, the step of spreading a layer of glue on a ply P, P′ is carried out after the steps of embossing a first ply P and a second ply P′. Indeed, the layer of glue is spread on the ply P, P′ after being embossed. Depending on where the dispenser 30 is positioned, the step of spreading a layer of glue on a ply P, P′ is further carried out before or simultaneously with the step of dispensing a stiffening substance on a ply P, P′.

Advantageously, the innovative positioning of the dispensers in the embosser rather than in the rewinding machine, and thus the application of the stiffening substance immediately after embossing the plies, allow to prevent the product from contacting the rollers, and thus prevent them from being contaminated.

The embosser, the converting line, and the process thus conceived are susceptible of numerous modifications and variants, all falling within the scope of the inventive concept; all furthermore, details are replaceable by technically equivalent elements. In practice, the materials used, as long as compatible with the specific use, as well as the contingent dimensions and shapes, can be any depending on the technical requirements.

The invention claimed is:

1. An embosser comprising:
a first embossing unit, comprising at least a first upper roller and a first lower roller coupled to each other and configured to contact each other; said first embossing unit being configured to emboss a first ply (P) of tissue paper wound between the first upper roller and the first lower roller;
a second embossing unit, comprising at least a second upper roller and a second lower roller coupled to each other and configured to contact each other; said second embossing unit being configured to emboss a second ply (P′) of tissue paper wound between the second upper roller and the second lower roller; the first lower roller and the second upper roller facing each other and being at least close defining a coupling zone (C) of said plies (P) and (P′);
a coupling roller placed downstream of the coupling zone (C) and coupled to the first lower roller or to the second upper roller; said coupling roller being configured to join the first ply (P) and the second ply (P′) from the first embossing unit and the second embossing unit to form a multi-layer ply (PP′);
a glue assembly placed upstream of the coupling zone (C) and associated to the first lower roller or the second upper roller, said glue assembly being configured to spread a layer of glue on the embossed first ply (P) or second ply (P′); and
at least one dispenser of a stiffening substance positioned at said first lower roller and/or said second upper roller; said dispenser being configured to dispense a predetermined amount of said stiffening substance on a predetermined area (A) of said embossed ply first ply (P) or second ply (P′) placed upstream of the coupling zone (C).

2. The embosser according to claim 1, comprising a plurality of dispensers placed side by side to each other; each dispenser being configured to dispense a predetermined amount of said stiffening substance.

3. The embosser according to claim 2, wherein each dispenser (30) is adapted to dispense the stiffening substance according to a spray cone defining said predetermined area (A); said plurality of dispensers being positioned so that said predetermined areas (A) are adjacent to each other along a direction transverse to an advancement direction (Y) of the ply (P) or (P′).

4. The embosser according to claim 3, wherein said plurality of dispensers are positioned so that said predetermined areas (A) are contiguous.

5. The embosser according to claim 3, wherein each dispenser (30) is configured to dispense said stiffening substance in subsequent times so as to cover said predetermined areas (A) that are adjacent along the advancement direction (Y) of the ply (P) or (P′) for a section ranging from 0.5 m to 2 m.

6. The embosser according to claim 2, wherein said plurality of dispensers (30) are configured to be inclined and/or rotated.

7. The embosser according to claim 1, wherein said predetermined amount of the stiffening substance ranges from 1 g/m² to 10 g/m².

8. The embosser according to claim 1, wherein said stiffening substance is a glue.

9. A converting line for processing tissue paper, comprising:
the embosser according to claim 1; and
a rewinding machine placed downstream of the embosser and configured to wind the multi-layer ply (PP′) forming logs in succession,
wherein said dispenser is configured to dispense said stiffening substance at predetermined times synchronously with said rewinding machine so that said predetermined area (A) defines a log innermost coil, adjacent to a core to be extracted.

10. A process to stiffen a ply of tissue paper to be coil-winded around a core to be extracted, said process comprising:
(i) embossing a first ply (P) of tissue paper;
(ii) embossing a second ply (P′) of tissue paper;
(iii) spreading a layer of glue on an embossed first ply (P) or second ply (P′);
(iv) joining the first ply (P) to the second ply (P′) forming a multi-layer ply (PP′); and
(v) subsequent to said embossing (i) and embossing (ii) and prior to said joining (iv), dispensing a stiffening substance on the first ply (P) or the second ply (P′),
wherein said dispensing (v) is separated from said spreading (iii) and is carried out for a shorter time than said spreading (iii).
